(19) United States
(12) Patent Application Publication
(10) Pub. No.: US 2014/0078069 A1
(43) Pub. Date: Mar. 20, 2014

(54) OBJECT DETECTION METHOD FOR MULTI-POINTS TOUCH AND THE SYSTEM THEREOF

(71) Applicant: Yung-Le Hung, Hsinchu City (TW)

(72) Inventor: Yung-Le Hung, Hsinchu City (TW)

(73) Assignee: GETAC TECHNOLOGY CORPORATION, Hsinchu (TW)

(21) Appl. No.: 13/619,162

(22) Filed: Sep. 14, 2012

(51) Int. Cl. G06F 3/041

(52) U.S. Cl. 345/173

(57) ABSTRACT

An object detection method and system for multi-points touch are disclosed. The method and system can be used in object processing and identification in the touch display device. The object detection system includes a touch display unit and an object. At least one division area is set in the touch display unit. The object has multiple contact objects. The object detection method includes receiving the first detection signal generated by the multiple contact objects being pressed in the first division area, determining the first shape form by the contact objects, and looking up the object mapping table according to the first shape so as to obtain the corresponding object. When the object operates on the touch display device, the corresponding operation can be displayed on the touch display device based on the object found in the object mapping table.

### BACKGROUND

1. Technical Field

The disclosure relates to an object detection method and system, and more particularly to an object detection method and system for multi-point touch.

2. Related Art

With development of touch electronic devices, more and more users tend to use smart phone or tablet PC for work and entertainment. Touch electronic devices can display information and also receive operation commands by touch panel.

Resistance touch screen and capacitance touch screen are two mainstreams of the touch display screens. The resistance touch screen acquires a user's press position by detecting resistance change when the resistance touch screen is touched. The capacitance touch screen acquires a user's press position by sensing the biological electrostatic induction.

Neither resistance touch screen nor capacitance touch screen can determine what means is used for inputting information. For example, both a user's finger and a touch pen can touch a resistance touch display unit to generate commands, but the touch display unit cannot distinguish the input way by general resistance change. The abovementioned types of touch screens can only distinguish the positions of touch points, and the sorts of commands are limited. In different applications, the limited sorts of commands can't satisfy the user's requirement of operating electronic device.

### SUMMARY

In one aspect, an object detection method for multi-points touch is disclosed. In this method, a first object is identified by a touch display unit, and the first object has at least three contact objects. The object detection method comprises setting at least one division area in the touch display unit, detecting whether multiple contact objects of the first object contact the touch display unit, the multiple contact objects contacting the touch display unit to form multiple contact points, identifying a first shape formed by the multiple contact points, looking up an object mapping table according to the first shape to find out the first object corresponding to the first shape, and calling a first operation according to the first object.

In another aspect, an object detection system for multi-points touch is disclosed. The object detection system comprises an object and a touch display device. The object has at least three contact objects. The touch display device has a processing unit, a storage unit, and a touch display unit. The processing unit is electrically connected to the storage unit and the touch display unit. The storage unit stores an object mapping table. A display region of the touch display unit is defined as at least one division area. When the contact objects of the object contact the touch display unit, multiple contact points are formed, and the processing unit identifies a first shape formed by the contact points and looks up a first operation of the object.

### BRIEF DESCRIPTION OF THE DRAWINGS

The present disclosure will become more fully understood from the detailed description given herein below for illustration only, and thus are not limitative of the present disclosure, and wherein:

FIG. 1 is an architecture diagram of the disclosure;

FIG. 2 shows an operation flow of the disclosure;

FIG. 3A is an object diagram of the disclosure;

FIG. 3B shows an object mapping table of the disclosure;

FIG. 3C is a contact point diagram that the objects contact the touch display unit of the disclosure;

FIG. 4A shows a background scrolling diagram of an object on the touch display unit before movement of the disclosure;

FIG. 4B is a background scrolling diagram of an object on the touch display unit after movement of the disclosure;

FIG. 4C is a diagram of a toy car before and after rotation of the disclosure;

FIG. 4D is a background scrolling diagram of the disclosure;

FIG. 5A is a sectional view of a toy car before pressing the active object of the disclosure;

FIG. 5B is sectional view of a toy car after pressing the active object of the disclosure;

FIG. 6A is a toy car and barrier's diagram of the disclosure;

FIG. 6B shows a toy car shooting bullets of the disclosure;

FIG. 7A shows the first and second division areas and the first and second objects of the disclosure;

FIG. 7B shows the second object's movement of the disclosure;

FIG. 7C shows the first object hitting Ping Pong ball of the disclosure;

FIG. 7D shows the Ping Pong ball's movement of the disclosure; and

FIG. 8 shows a flowchart of newly added objects for the object mapping table of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

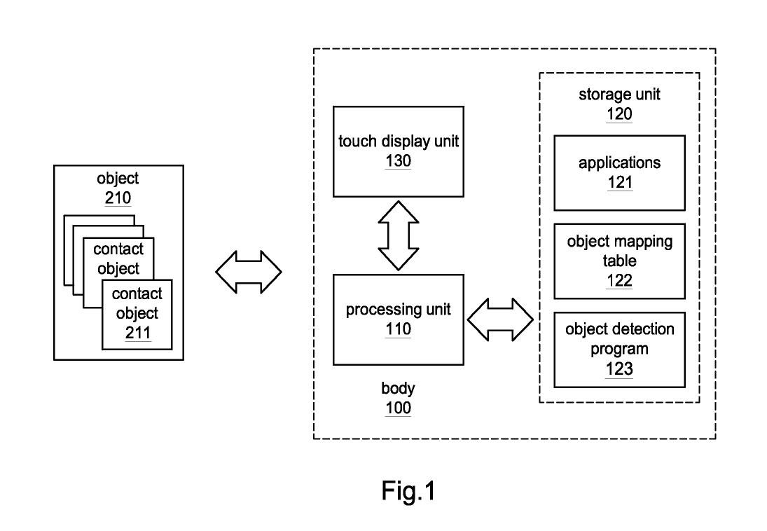

The present disclosure may be applied in a mobile phone, a tablet Personal Computer (PC), a notebook, a media player, a Personal Digital Assistant (PDA), or the combination thereof. FIG. 1 is the architecture diagram of the present disclosure. The object detection system of the present disclosure comprises a display device body 100 (herein after referred to as the body 100) and the object 210.

The appearance of the object 210 can be designed according to different applications. It should be noted that the object 210 comprises at least three contact objects 211. When the contact objects 211 contact the touch display unit 130, contact points will be generated. Furthermore, the contact points may form different shapes due to different number of the contact objects 211. For example, three contact objects 211 may form a right triangle or an equilateral triangle. Four contact objects 211 may form a square, a rectangle, or a trapezoid. Five contact objects 211 may form a regular pentagon or an ordinary pentagon. Other number of contact objects 211 may form other shapes which will not be illustrated here again.

The body 100 at least comprises a processing unit 110, a storage unit 120, and a touch display unit 130. The processing unit 110 is electrically connected to the storage unit 120 and the touch display unit 130. The storage unit 120 may be but is not limited to be a flash memory, Read Only Memory (ROM), Random Access Memory (RAM), Hard Disk (HD), or the combination thereof. The storage unit 120 is used to store the operation system of the touch display unit, various applications 121, the object mapping table 122, and object detection program 123. The applications 121 may comprise media player, browser, address book, notepad, games, etc. The processing unit 110 may call a corresponding application 121 from the storage unit 120 according to users' requirement. The object mapping table 122 is used to record different objects 211 and the control operations corresponding to the objects 211 (the type of the operation and the performed content will be explained below).

The touch display unit 130 may be implemented by capacitance sensing, resistance sensing, Infrared Radiation (IR) sensing, ultrasonic wave sensing, and etc. When the object 210 contacts the touch display unit 130, the processing unit 110 receives the corresponding signal sent from the touch display unit 130. In addition, the touch display unit 130 may display the operation state of the body 100 or the calculation results of the applications 121. Alternatively, the touch display unit 130 may display the operation hint. For example, when the processing unit 110 executes the media player, the touch display unit 130 may display the user interface of the media player. Furthermore, when the body 110 performs a calling program, the touch display unit 130 may display function keys for dialing the calling number.

The display region of the touch display unit 130 may have at least one division area. The size of the division area is not limited. For example, the size of the division area may be equal to the area of the shape formed by the contact points. Also, the size of the division area may be the whole or a half of the display region of the touch display unit 130. The initial position of the division area is determined according to the settings of different applications. The size and number of the division areas could be determined by the size of the shape formed by the contact points of the object 210 and number of the object 210. The time for setting the division area may be determined during the booting process of the body 100 or the process of performing a related application 121. Furthermore, the touch display unit 130 may (or may not) display the division area.

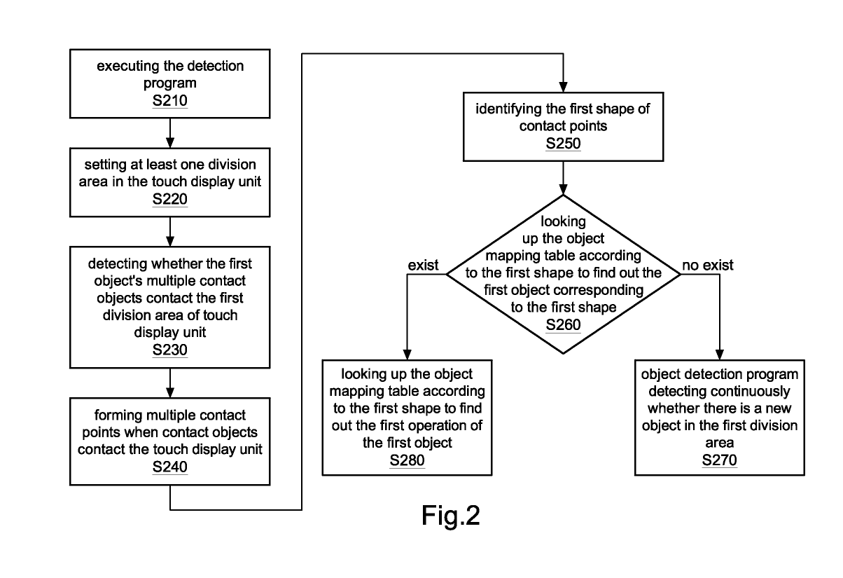

The object detection program 123 may be independently executed in the operation system or be executed as a library which is called by the application 121. In order to explain the operation flow of the object detection program 123, please refer to FIG. 2. FIG. 2 illustrates the operation flow according to an embodiment of the disclosure. The object detection method shown by FIG. 2 comprises the following steps.

step S210: executing the detection program;

step S220: setting at least one division area in the touch display unit;

step S230: detecting whether a plurality of contact objects of the first object contact the first division area of the touch display unit. The first object has at least three contact objects;

step S240: forming a plurality of contact points when the contact objects touch the touch display unit;

step S250: identifying the first shape formed by the contact objects;

step S260: looking up the first object corresponding to the first shape in the object mapping table;

step S270: the object detection program continues to detect whether there is a new object in the first division area if the first object does not exist in the object mapping table,; and

step S280: looking up the first operation of the first object in the object mapping table according to the first shape to find out the first operation of the first object if the first object exists in the object mapping table.

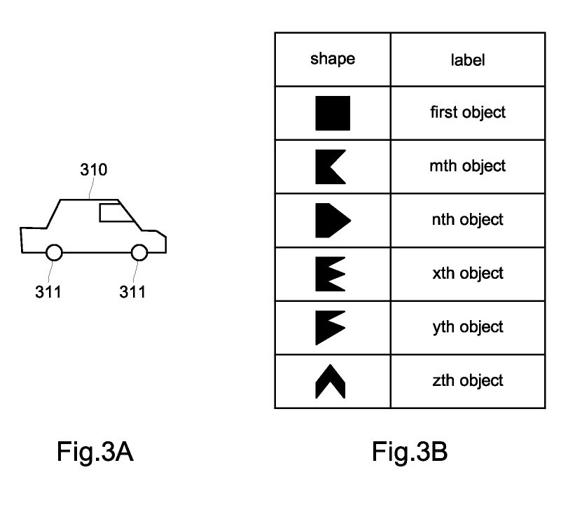

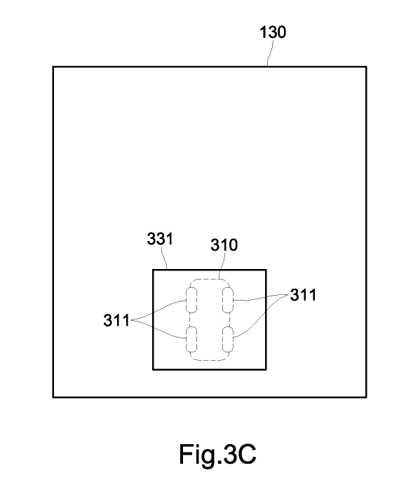

In order to differentiate different objects 210, the following will use a first object 310 and a second object for illustration with reference to FIG. 3A. Other objects may be used in the disclosure, and the number of the objects is not limited this way. Furthermore, different division areas may be defined as a first division area 331, a second division area (not shown in FIG. 3C), or a third division area (not shown in FIG. 3C). The size of the first division area 331 is not limited as shown in FIG. 3C. The size of the first division area 331 may be the whole or a half size of the display region of the touch display unit 130.

The processing unit 110 may independently execute the object detection program 123 in the operations system. Alternatively, when the processing unit 110 executes a particular application 121, the processing unit 110 will call the object detection program 123. The processing unit 110 will set at least one division area in the touch display unit 130 when the object detection program 123 initiates. Different division areas may be assigned to different objects 210 respectively. For example, the first object 310 may be assigned to the first division area 331, and the second object may be assigned to the second division area.

Then, the object 210 is placed in the first division area 331 and the contact objects 311 contact the touch display unit 130. The contact points are generated when the contact objects 311 contact the touch display unit 130, and thus the touch display unit 130 will generate a corresponding touch signal.

As mentioned above, the number of the contact objects 311 may be different according to the type of the object 210. That is, the number of the contact points may be different according to the number of the contact objects 3111. After the object detection program 123 is executed, if the object 210 is placed on the touch display unit 130 (i.e., in the first division area 331), the processing unit 110 will identify the first shape formed by the contact objects. The processing unit 110 looks up the first object 310 in the object mapping table 122 according to the first shape so as to determine whether the first shape has the corresponding first object 310.

The object mapping table 122 stores mapping relations between shapes and objects, as shown in FIG. 3B. In FIG. 3B, different shapes correspond to different objects. Each object corresponds to a label respectively. The processing unit 110 may further find out the object label according to the identified shape.

If the object mapping table 122 records the first shape, the processing unit 110 may identify the object 210 as the first object 310. If the object mapping table 122 does not record the first shape, the error information that “it cannot be identified” is displayed on the touch display unit 130. If the processing unit 110 identifies the object 210 as the first object 310, the processing unit 110 will call the first operation of the first object 310 from the object mapping table 122. The first operation refers to the response the touch display unit 130 generates when the first object 310 is in operation on the touch display unit 130 (or display different images on the touch display unit 130).

For example, the first operation may be the scrolling speed of the background in the touch display unit 130, or displaying the handwriting on the touch display unit 130 by the first object 310, or any operation from the touch display unit 130 according to user's action on the first object 310.

When the user acts on the first object 310 on the touch display unit 130 (for example, moving the first object 310), the processing unit 110 will apply the first operation corresponding to the first object 310. After the first object 310 is identified, the first object 310 may or may not operate in the first division area 331. In other words, the first object 310 may move in the whole display region of the touch display unit 130.

Similarly, a second division area may be set in the display region of the touch display unit 130. When a user puts another object in the second division area, the processing unit 110 looks up the object mapping table 122 by the above mentioned way in order to determine whether the object mapping table 122 records the label corresponding to the object. Once the processing unit 110 identifies the object as the second object, the processing unit 110 uses the corresponding second operation of the second object.

FIG. 3A shows an embodiment of an object. FIG. 3C shows the contact points when the contact objects of the object of FIG. 3A contact the touch display unit. With reference to FIG. 3A, the first object 310 is a toy car. Hereafter the toy car represents the first object 310. Each tyre of the toy car is a contact object 311. The toy car has four tyres and it means that there are four contact objects 311. The contact points of the four contact objects 311 form a rectangle. The dotted box in FIG. 3C represents the first division area 331. FIG. 3C shows a top view of the touch display unit according to an embodiment of the disclosure. The first object 310 (i.e., toy car) of FIG. 3A is put in the first division area 331 as shown in FIG. 3C. When the toy car is put in the first division area 331, four tyres (i.e., the four contact objects 311) contact the touch display unit 130. At the same time, the touch display unit 130 receives the corresponding contact points. The processing unit 110 receives the corresponding touch signals.

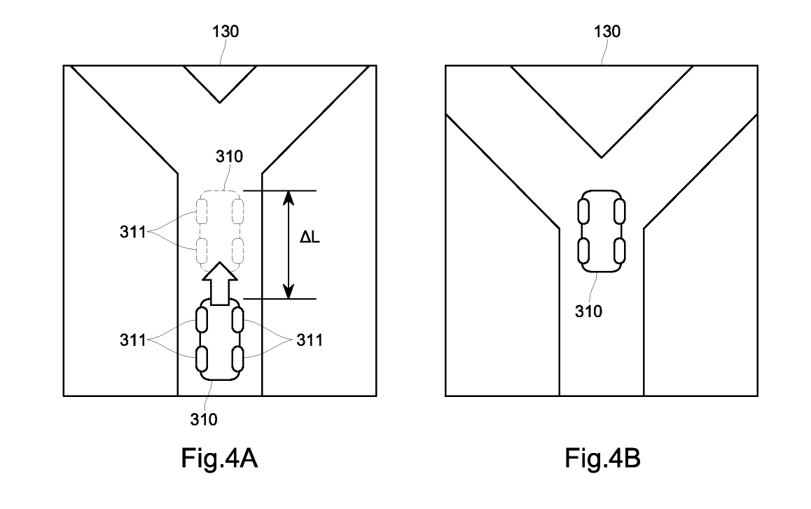

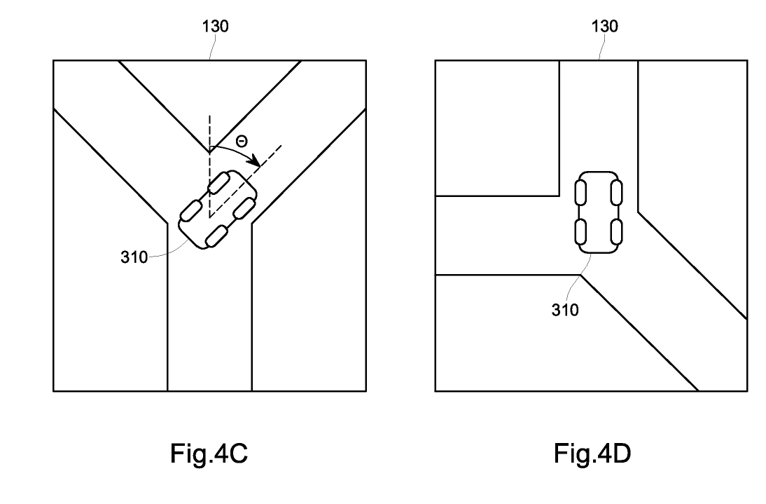

Then, the processing unit looks up the object mapping table 122 according to the shape formed by the contact objects 311. In particular, the processing unit 110 identifies whether the contact points form the first shape according to the side length of the shape and the angle formed between two sides. After the processing unit 110 identifies the first shape, the processing unit 110 looks up the object mapping table 122 according to the first shape, and obtains the corresponding operation of the first shape from the object mapping table 122. Take the toy car for example, the operation for the toy car refers to the scrolling direction and speed of the background of the touch display unit 130 according to the toy car's movement direction and speed on the touch display unit 130. FIGS. 4A and 4B illustrate the background scrolling when the object moves on the touch display unit.

In FIG. 4A, the toy car moves on the touch display unit 130. The solid line represents the initial position of the toy car, and the dashed line represents the position of the toy car which takes a movement after. The movement distance is represented as A L. When the toy car moves forwards as shown in FIG. 4A, the background in the touch display unit 130 changes as shown in FIG. 4B. In this way, a user may sense the movement of the toy car as well as the background scrolling.

When the toy car moves at the fork road, the user may rotate the toy car. As shown in FIG. 4C, the toy car rotates for an angle θ. When the toy car rotates for a certain angle, the processing unit receives the changed contact points and rotates the background of the touch display unit 130, as shown in FIG. 4D. That is, the background in the touch display unit 130 also rotates for the angle θ.

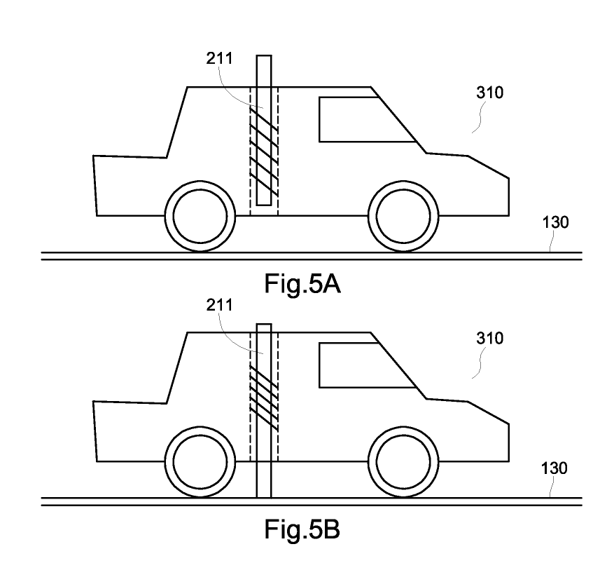

In addition, another active object 211 may be set in the object 210. The active object 211 may be set by an elastic element (e.g., spring), pin switch, or other elements which can take a reciprocating motion. In FIG. 5A, the active object 211 is set in the toy car. When the active object 211 is not pressed, the active object 211 does not contact the touch display unit 130 due to the spring. On the other hand, when the active object 211 is pressed, the active object 211 can contact the touch display unit 130 due to the compression of the spring, as shown in FIG. 5B.

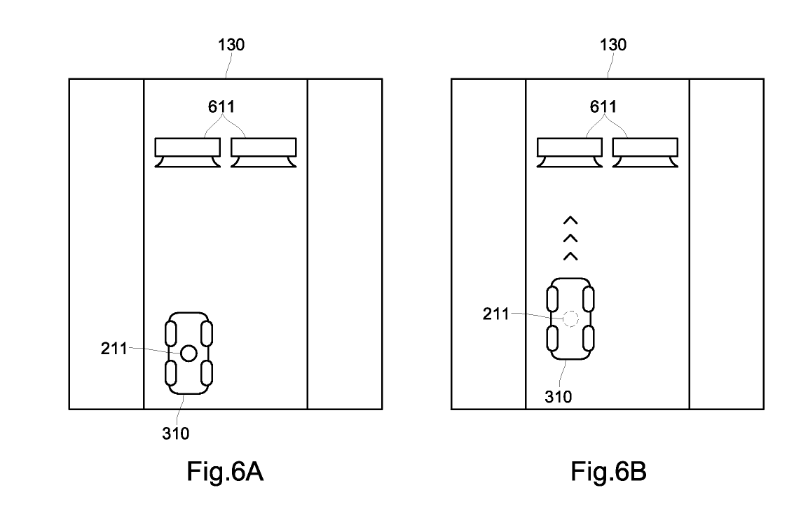

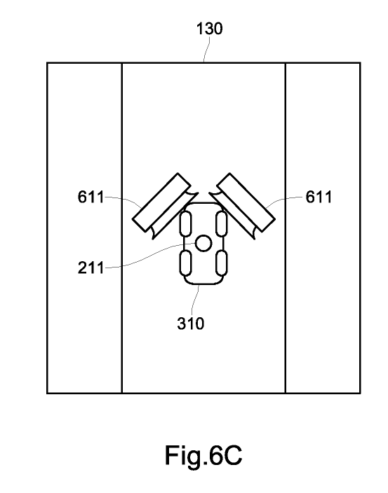

When the toy car moves on the touch display unit 130, the active object 211 may be pressed selectively. When a user presses the active object 211, the processing unit 110 performs a corresponding action. For example, in FIG. 6A, when the toy car meets the barrier, the user may press the active object 211. When the active object 211 contacts the touch display unit 130, the processing unit 110 may find out the corresponding first object from the object mapping table 122 according to the first shape. The third operation for the toy car in FIG. 6A may be “firing bullets”. Therefore, when a user presses the active object 211, the touch display unit 130 displays the fired bullets according to the position of the toy car. The bullet is shown by the symbol “A” in FIG. 6B. Furthermore, when the active object 211 is pressed, the number of the contact objects changes and thus the first shape changes. When the first shape changes, the first operation will be switched to the third operation.

Alternatively, the user may force the toy car to crash into the barrier 611, as shown in FIG. 6C. This movement can also be considered as an operation in the present disclosure. The processing unit 110 will update the display of the barrier 611 according to the crash speed to the barrier 611. As a result, the toy car may not only have interaction with the background but also with other objects in the touch display unit 130.

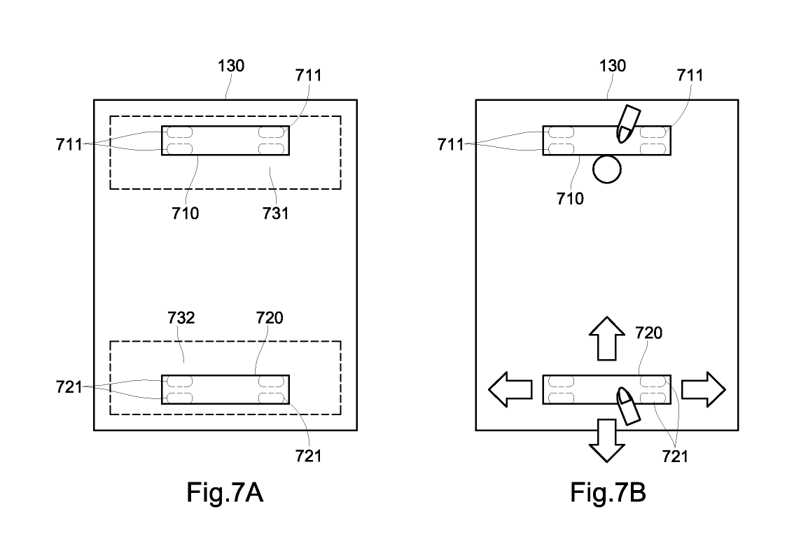

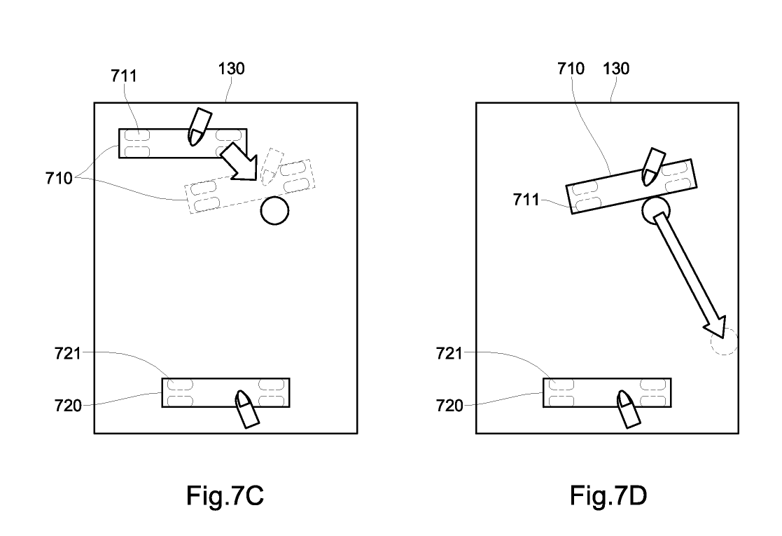

A single object 210 or multiple objects 210 may be identified using the technique in this disclosure. As shown in FIG. 7A, the third object is at the upper portion of the touch display unit 130, and the fourth object is at the lower portion of the touch display unit 130. In order to differentiate from the first and second objects described above, the third object (i.e., the first racket) and the fourth object (i.e., the second racket) are used in the following example. Furthermore, the third division area 731 and the fourth division area 732 are used in the following example. After the object detection program 123 is started, a user may put the third object in the third division area 731 and put the fourth object in the fourth division area 732. After each object is identified, the processing unit 110 will find out the operation for each object. Then, each object can move anywhere in the touch display unit 130. During the movement of the objects, the processing unit 110 may apply a corresponding action for an object.

As shown in FIG. 7A and 7B, application 121 is a Ping Pong application for example. First, the Ping Pong application is executed and the object detection program 123 is called. Then a user puts the first racket 710 and the second racket 720 into the third division area 731 and the fourth division area 732 respectively. After the processing unit 110 identifies the objects, the user may move the first racket 710 and the second racket 720 as shown by the arrow in FIG. 7B.

After that, the user moves the first racket 710 in order to hit the Ping Pong ball as shown in FIG. 7C. In FIG. 7C, the solid frame represents the position of the first racket 710 before movement, and dashed frame represents the position of the first racket after movement. The processing unit calculates the corresponding movement speed of the racket according to the movement distance and duration time of the first racket 710. The processing unit 110 changes the position of the Ping Pong ball in touch display unit 130, so the Ping Pong ball changes the current position and motion trail following the hit of racket, as shown in FIG. 7D. While another user may move the second racket 720 to hit back the Ping Pong ball.

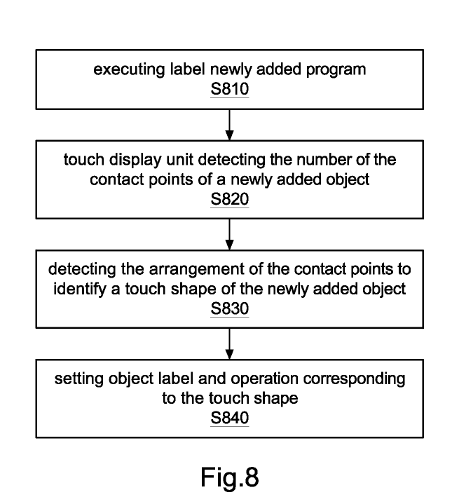

The present disclosure may add new objects and control operations for the lookup table besides the above corresponding objects in lookup table. Please refer to FIG. 8, it is the flow chart of new added objects for lookup table of the present disclosure. The flow of new added objects includes following steps:

Step S810: executing the label new adding program;

Step S820: the touch display unit detecting the number of the contact points of a newly added object;

Step S830: detecting the arrangement of contact points to identify the touching shape of a new added object; and

Step S840: setting the corresponding object label and control operation of the contact shape.

First, the label newly added program in the body 100 is executed. When the label new adding program is executed, the touch display unit 130 detects whether object 210 is placed on it or not. The object 210 is defined as a new added object. The touch display unit 130 determines the shape according to the array mode of touch unit 211. For example, if the new added object has three touch units 210 and the touch units 210 touches the touch display unit 210, the contact point is generated. After that, the touch display unit 130 generates corresponding signal. The processing unit 110 recognizes the shape of the contact point according to the received signal and the position on the touch display unit. Therefore, the processing unit 110 may determine that the added object corresponds to a triangle (or a right triangle, isosceles triangle, or other shapes) according to the positions of these contact points.

If the processing unit 110 cannot determine the shape formed by the contact points, the user may directly select a corresponding shape from the touch display unit 130, or draw a corresponding shape on the touch display unit 130. After finishing the corresponding relations between the added objects and shapes, new operations for the added objects will be defined. The newly operations may be selected from the internal operation set or defined completely new. The step of defining new operation may comprise incorporating the external program into the body 100. For example, the information of newly defined operation may be uploaded into the body 100 by the Universal Serial Bus (USB) connected to the body 100.

The multi-point object detection method, operation method, and the object detection system disclosed in the disclosure may identify different objects and thus design corresponding operations.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. An object detection method for multi-points touch, used to identifying a first object by a touch display unit, the object detection method comprising:
setting at least one division area in the touch display unit;
detecting whether multiple contact objects of the first object contact the touch display unit, wherein the first object having at least three contact objects;
forming multiple contact points when the multiple contact objects contacts the touch display unit;
identifying a first shape formed by the multiple contact points;
looking up the first object corresponding to the first shape in an object mapping table; and
calling a first operation according to the first object.

2. The object detection method according to claim 1, wherein the division areas do not overlap with each other.

3. The object detection method according to claim 2, wherein the touch display unit detects the contact points which are generated by the multiple contact objects of a second object and form a second shape in a second division area, and looks up the second object corresponding to second shape in the object mapping table to find out a second operation corresponding to the second object, wherein the second object having at least three contact objects.

4. The object detection method according to claim 3, wherein after the step of finding out the second operation for the second object, the object detection method further comprising:
executing the second operation corresponding to the second object by the touch display unit when the second object moves on the touch display unit.

5. The object detection method according to claim 1, wherein after the step of finding out the first operation corresponding to the first object, the object detection method further comprising:
performing the first operation corresponding to the first object by the touch display unit when the first object moves on the touch display unit.

6. The object detection method according to claim 5, further comprising:
identifying the number of the contact points and change of the first shape by the touch display unit during the period of performing the operation;
finding out a third operation from an action look-up table if the number of the contact points changes; and
performing the third operation by the touch display unit.

7. An object detection system for multi-points touch, comprising:
an object having at least three contact objects; and
a touch display device, having a processing unit, a storage unit, and a touch display unit, the processing unit being electrically connected to the storage unit and the touch display unit, the storage unit storing an object mapping table, a display region of the touch display unit being defined as at least one division area;
wherein, when the contact objects of the object contact the touch display unit, multiple contact points are formed, and the processing unit identifies a first shape formed by the contact points and looks up a first operation of the object.

8. The object detection system according to claim 7, wherein after the processing unit finds out the first operation of the object, the processing unit performs the first operation of the object when the object moves on the touch display unit.

9. The object detection system according to claim 8, wherein the object further comprising an active object, when the object being on the touch display unit, the active object selectively contacts the touch display unit or moves away from the touch display unit.

10. The object detection system according claim 9, wherein when the active object contacts the touch display unit, the processing unit performs a third operation of the object.
